(19) United States
(12) Patent Application Publication
(10) Pub. No.: US 2001/0044490 A1
(43) Pub. Date: Nov. 22, 2001

(54) STRUCTURAL FILLER STRUCTURAL PASTE

(76) Inventor: DIETER ZIMMERMANN, LANGENZENN (DE)

Correspondence Address: CHARLES R HOFFMANN, HOFFMANN & BARON, 6900 JERICHO TURNPIKE, SYOSSET, NY, 11791, US

(21) Appl. No.: 09/462,921

(22) PCT Filed: Jun. 25, 1998
(86) PCT No.: PCT/DE98/01799

§ 371 Date: None

(30) Foreign Application Priority Data
Jun. 17, 1997 (DE) 297 12 628.8

(51) Int. Cl. C08K 3/34; C08K 11/00

(52) U.S. Cl. 524/492; 524/442

(57) ABSTRACT

The subject of the invention is a structural cement based on unsaturated polyester, acrylic or epoxy resins as a bonding agent and with pigments, filling and structural materials, wherein the composition contains at least one rheological additive and/or at least one drying additive.

The present invention concerns a structural cement based on unsaturated polyester, acrylic or epoxy resins as a bonding agent and with pigments, filling and structural materials, as well as a structural paste for modifying the structural cement.

A structural cement of that kind is known for example from Utility Model DE 295 08 712 U1 and, besides being used as a cement material, is also used as a jointing material or repair or filling material for artificial or natural stones. In the above-indicated Utility Model, a better degree of optical matching of the structural cement to the natural stones which involve a very wide range of variations is achieved by the additional admixing of a mixture of nacre and shell lime, or nacre, shell lime and coral lime.

This structural cement which is known from the state of the art suffers however from some serious disadvantages. The first which is to be mentioned in that respect is that it will only keep for a short period of time because a sediment which can scarcely be homogenized again is already formed with a storage time of some weeks. In addition the mechanical properties of this structural cement and in particular the surface workability and adhesion are still in need of improvement.

Therefore the object of the present invention is to provide a further structural cement which does not have at least some of the disadvantages known from the state of the art and which is economical to produce, and a structural paste for modifying and matching the optical appearance of the structural cement.

That object is attained by a structural cement of the kind set forth in the opening part of this specification, in that the composition contains at least one rheological additive and/or at least one drying additive.

That object is further attained by a structural paste based on unsaturated polyester, acrylic or epoxy resins as bonding agent and with structural materials, in that the composition contains between 20 and 80% by weight of bonding agent, between 0.5 and 10% by weight of at least one rheological additive and between 20 and 80% by weight of structural materials.

Surprisingly a relatively small amount of rheological additive in the structural cement according to the invention already results in substantially improved preservability. In contrast to the structural cement known from the state of the art, the structural cement according to the invention can be kept not just for some weeks but over twelve months, in which respect preservability thereof is to be attributed in particular to the fact that the sediment which forms upon storage remains easily homogenizable by virtue of the content of Theological additive. An equally comparatively small amount of at least one drying additive influences not only the drying behaviour of the structural cement according to the invention but also contributes in an unexpected manner to an improved surface characteristic and workability of the structural cement according to the invention. To achieve the above-indicated advantages, there is no need for the at least one rheological additive and the at least one drying additive to be present jointly, although that is preferred as in that way the positive effects of the two kinds of additives are combined.

Although the consistency of the structural paste according to the invention basically does not from the outset promote sinking and lump formation of the solid constituents, improved preservability and in addition improved workability with the structural cement according to the invention is also unexpectedly to be found with the structural paste according to the invention. In that respect there is no need to add a drying additive to the present structural paste.

The rheological additives used in the structural cement and structural paste are preferably silicas which are unmodified or modified with organic groups, such as for example alkyl groups, and precipitated or in a highly dispersed condition, hardened or unhardened castor oil derivatives, non- or organically modified stratified silicates and polyamides, while in the case of the structural cement, for example preferably paraffins or derivatives synthetically derived from paraffins are used as drying additives.

An entire series of generally known fillers which are used in this field are available as fillers for the man skilled in the art, in which respect however in particular talc, barytes, calcite, dolomite, powdered quartz, aluminum oxide or hydroxide and kaolin are preferred. The grain size of those fillers is appropriately in the range of between 0.1 and 150 μm.

In order to permit better adaptability to the wide range of variations in regard to the natural stones, so-called structural materials are used as a constituent of the structural cement composition according to the invention. Here particular emphasis is to be put on mica, pearlized pigments, metal effect pigments and coarse kinds of talcum.

The range in variation and adaptability of the structural cement according to the invention is in that respect advantageously further increased by the use of the structural paste according to the invention, in which respect the same structural materials can be used in the structural paste according to the invention as in the structural cement. As the optical appearance of the structural cement can be adapted in accordance with the demands involved by admixing between 2 and 30% by weight of structural paste, that entails the particular advantage that a relatively small number of different structural cements have to be prepared, as they can be suitably matched by admixing a suitable amount of a suitably selected structural paste in accordance with the invention.

In addition the structural paste is also suitable for modifying mastic cements and stone cements or adhesives which are already conventional.

Pigments are also contained in the structural cement according to the invention and here the man skilled in the art can select from a large number of natural and synthetic pigments, of inorganic or organic kind. For example, oxides of titanium, iron, chromium, cobalt as well as carbon blacks are frequently used, as examples of inorganic pigments, and phthalocyanines as well as axo dyes, as examples of organic pigments, for which reason they are also preferably contained in the structural cement according to the invention.

The bonding agents used in the structural cement according to the invention and the structural paste according to the invention are unsaturated polyester or acrylic resins, pure or dissolved in a monomer such as for example styrene, alpha-methylstyrene, hexane diol dimethacrylate, methyl methacrylate. The unsaturated polyester or acrylic resins used are unaccelerated or accelerated with amine, for example N, N-dimethyl-p-toluidine, N,N-di-2-hydroxyethyl-p-toluidine, dimethylaniline or metal such as Co. The specified unsaturated polyester or acrylic resins are hardened in the usual manner with organic peroxides such as for example dibenzoyl-, methyl ethyl ketone or cyclohexanone peroxide, as well as UV-initiators and UV-light. Epoxy resins based on bisphenol A, bisphenol F or cycloaliphatic glycidyl ether are also used as the bonding agents. The stated epoxy resins are used with or without reactive diluents such as for example hexane diol diglycidylether, o-cresylglycidylether, and corresponding hardeners on an amine, mercaptan, anhydride or acid basis, such as for example isophorondiamine, xylylene diamine, hexahydrophthalic acid anhydride and terephthalic acid.

The following Examples of the structural cement according to the invention and the structural paste according to the invention serve to further describe the invention.

### EXAMPLE 1

Structural cement based on unsaturated polyester resin.

462 g of unsaturated, amine-accelerated unsaturated polyester resin dissolved in styrene is mixed with 10 g of rheological additives, 0.9 g of titanium dioxide, 0.75 g of iron oxide pigments, 98 g of structural pigments, 1.5 g of drying additives and 520 g of fillers and dispersed in a high-power agitator apparatus.

Hardening of that structural cement is effected by adding between 1 and 4% of dibenzoyl peroxide (between 40 and 50%) at ambient temperature and is concluded after between 10 and 20 minutes.

### EXAMPLE 2

Structural cement based on epoxy resin.

### Component A

600 g of epoxy resin comprising bisphenol A and bisphenol F-epichlorhydrin resin with a bifunctional reactive diluent are mixed with 14 g of Theological additives, 3 g of titanium dioxide, 1.5 g of iron oxide pigments, 90 g of structural pigments and 400 g of fillers and dispersed in a high-power agitator apparatus.

### Component B

560 g of cycloaliphatic polyamine are mixed with 14 g of rheological additives and 500 g of fillers and dispersed in a high-power agitator apparatus.

Hardening is effective by mixing two parts by volume or weight of component A with one part by volume or weight of component B and after between 12 and 16 hours has progressed to such a degree that parts which are cemented or glued therewith can be loaded or worked. The final strength is attained after about 1 week.

### EXAMPLE 3

Structural paste based on unsaturated polyester resin.

500 g of unsaturated polyester resin dissolved in styrene is mixed with 10 g of rheological additive and 490 g of structural pigment and dispersed in a high-power agitator apparatus.

To modify the structural cement according to the invention between 2 and 30% by weight of that structural paste is mixed with the structural cement, depending on the respective requirements involved.

1. A structural cement based on unsaturated polyester, acrylic or epoxy resins as bonding agent and with pigments, filling and structural materials, characterised in that the composition also contains at least one rheological additive and/or at least one drying additive.

2. A structural cement as set forth in claim 1 characterised in that the composition contains
between 20 and 60% by weight of bonding agent,
between 0.5 and 10% by weight of at least one rheological additive, between 0.1 and 5% by weight of inorganic and/or organic pigments,
between 4 and 30% by weight of structural materials,
between 0 and 70% by weight of filler materials, and
between 0.1 and 0.50% by weight of at least one drying additive.

3. A structural cement as set forth in claim 1 or claim 2 characterised in that one or more compounds, selected from precipitated or highly dispersed silica which is unmodified or modified with organic groups, hardened or non-hardened castor oil derivatives, non- or organically modified stratified silicates and polyamides are contained as rheological additive.

4. A structural cement as set forth in one of claims 1 through 3 characterised in that paraffins or derivatives synthetically derived therefrom are contained as a drying additive.

5. A structural cement as set forth in one of the preceding claims characterised in that one or more of talc, barytes, calcite, dolomite, powdered quartz, aluminum oxide or hydroxide and kaolin are contained as filling materials.

6. A structural cement as set forth in one of the preceding claims characterised in that the filling materials are of a particle size of between 0.1 and 150 μm.

7. A structural cement as set forth in one of the preceding claims characterised in that mica, pearlized pigment or pigments, metal effect pigment or pigments and/or coarse kinds of talcum are contained as a structural material.

8. A structural cement as set forth in one of the preceding claims characterised in that the composition contains
between 30 and 55% by weight of bonding agent,
between 0.8 and 3% by weight of at least one rheological additive,
between 0.14 and 4.1% by weight of inorganic and/or organic pigments,
between 4 and 15% by weight of structural materials,
between 0.1 and 0.3% by weight of drying additives, and
between 30 and 60% by weight of filling materials.

9. A structural paste based on unsaturated polyester, acrylic or epoxy resins as bonding agent and with structural materials, characterised in that the composition contains
between 20 and 80% by weight of bonding agent,
between 0.5 and 10% by weight of at least one rheological additive, and
between 20 and 80% by weight of structural materials.

10. A structural paste as set forth in claim 9 characterised in that one or more compounds, selected from precipitated or highly dispersed silica which is unmodified or modified with organic groups, hardened or non-hardened castor oil derivatives, non- or organically modified stratified silicates and polyamides are contained as rheological additive.

11. A structural paste as set forth in claim 9 or claim 10 characterised in that mica, pearlized pigment or pigments, metal effect pigment or pigments and/or coarse kinds of talcum are contained as a structural material.

12. A mixture of a structural cement as set forth in one of claims 1 through 8 with a structural paste as set forth in one of claims 9 through 11 characterised in that between 70 and 98% by weight of structural cement and between 2 and 30% by weight of structural paste are contained in the mixture.
